(19) United States
(12) Patent Application Publication
(10) Pub. No.: US 2023/0242349 A1
(43) Pub. Date: Aug. 3, 2023

(54) DRIVE STATION

(71) Applicant: Bühler AG, Uzwil (CH)

(72) Inventor: Markus HUBER, Hemau (DE)

(21) Appl. No.: 17/999,776

(22) PCT Filed: May 26, 2021
(86) PCT No.: PCT/EP2021/064004

§ 371 Date: Nov. 23, 2022

(30) Foreign Application Priority Data
May 29, 2020 (EP) 20177298.5

(51) Int. Cl. B65G 19/14; B65G 23/14; B65G 23/22; B65G 45/26; B65G 21/08

(52) U.S. Cl. CPC B65G 19/14; B65G 23/14; B65G 23/22; B65G 45/26; B65G 21/08

(57) ABSTRACT

The present invention relates to a drive station for a device for conveying bulk material, the drive station comprising: - a housing, which has a base plate and side walls, at least one side wall having at least one opening for the passage of a conveying means for conveying the bulk material along a passage path; and — a drive for moving the conveying means, the drive being disposed in the housing. A preferably movable intermediate base having openings is disposed below the passage path and above the base plate in the vertical direction.

The present disclosure relates to a drive station for a device for conveying bulk material, and a method for removing bulk material from a drive station.

During the transport of bulk materials by means of conveyor belts, bucket conveyors, pusher conveyors or similar devices, deposits of product or product residues can arise in parts of the system during operation, in particular in the drive station of the system. Particularly in the case of goods for food production or other goods that have high purity requirements, contamination of the product with residues returning to the product cycle from the system or drive station must be avoided. Therefore, the drive station must be cleaned at regular intervals in order to prevent a backflow of contaminated product. For this purpose, in many cases the system must be stopped, and the drive station must be opened and cleaned by qualified personnel.

US 4 257 518 A discloses a conveyor belt system with a scraper to clean the conveyor belt and a conveyor to remove residues in the housing. EP 2 121 490 A2 makes use of brushes to clean the conveying means of a pneumatic conveyor. CN 102 818 272 A discloses a conveyor belt with brushes attached thereto, which transport residues in the housing to a dust outlet. US 3 831 751 A describes a separating device with a conveyor for loose material.

Therefore, the object of the present disclosure is to provide a drive station that can be reliably cleaned during operation and without specific knowledge.

This is achieved by the features of the independent claims defining the invention. The dependent claims describe preferred embodiments.

The present invention comprises a drive station for a device for conveying bulk material, wherein the drive station comprises: a housing having a base plate and side walls, wherein at least one side wall has at least one opening for the passage of a conveying means for conveying the bulk material along a passage path, and a drive for moving the conveying means, wherein the drive is arranged in the housing. An intermediate base having openings is arranged below the passage path and above the base plate in the vertical direction. The intermediate base can be movable, in particular horizontally or also at an angle obliquely to the base plate.

The intermediate base can have a grate. Below the (movable) intermediate base, a stationary intermediate base also having openings can additionally be attached. Preferably, due to a movement of the intermediate base, the openings of the bases are optionally aligned or offset relative to each other.

The movable intermediate base can be moved by means of a drive, in particular a motor or also, for example, a pneumatic drive or other drive. The movable intermediate base can be moved by means of a lever or handle attached to the outside of the housing.

A chamber can be formed below the movable intermediate base, wherein at least one collecting container, in particular a drawer, is preferably arranged in the chamber.

Preferably, the collecting container can be displaced along guides and removed from the housing.

The openings of the movable intermediate base and/or the stationary intermediate base are preferably round, oval, elongated or angular.

The drive can be a chain drive or a roller drive, or a worm drive, a belt drive or any other form of drive.

The chamber can be closed by means of a removable cover or a flap.

The invention also comprises a method for removing bulk material from a drive station, preferably as described above, wherein the method comprises moving a preferably movable intermediate base provided with openings in the drive station.

Preferably, when the intermediate base is moved, residues of bulk material conveyed by a conveying device driven by the drive station, which have accumulated within the drive station, are transferred to a chamber or collecting container arranged below the intermediate base. Alternatively, the intermediate base can be stationary, and the bulk material residues can be moved to the chamber located under the intermediate base by moving the drive station. Furthermore, bulk material residues can be removed from the drive station by cleaning the chamber or pulling out and emptying the drawer. According to the invention, the method, and in particular the cleaning of the chamber or the extraction and emptying of the drawer, can be carried out in particular during the operation of the drive station, i.e. during the operation of the conveying device, because the conveying means and drive unit are shielded by the intermediate base, and thus the operator cannot reach in.

The invention is described with reference to the accompanying figures. The following is shown:

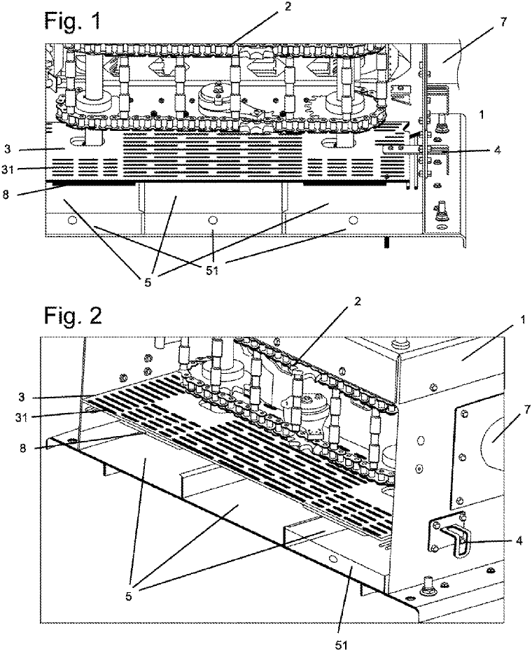

FIG. 1 a view of an exemplary drive station according to one embodiment,

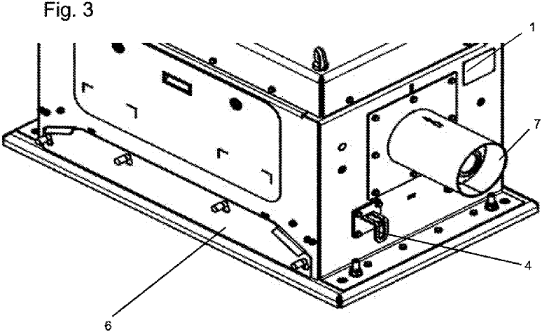

FIG. 2 a further view of an exemplary drive station according to one embodiment,

FIG. 3 an exterior view of an exemplary drive station according to one embodiment.

The present disclosure can have application in various systems for the transport of bulk material. These include screw conveyors, trough chain conveyors, belt conveyors, elevators or the like. All systems have in common that a drive station is necessary to move the respective conveying means. The drive station typically has a housing with a base plate, side walls, and a ceiling plate, which has at least one opening through which the conveying means is guided into the interior of the housing. In particular, the opening can be provided in one side wall, or in two opposite side walls of the housing. A drive is provided in the housing itself to move the conveying means. However, during operation, residues on the conveying means or even residues of the product to be conveyed can enter the drive station and can be deposited there. Furthermore, metal abrasion or other signs of wear can also arise, wherein residues are deposited in the drive station. This can impair the operation of the drive and lead to the contamination of the product by returning the deposits to the product circuit. This must be avoided, in particular for products with high hygiene requirements, for example in food production. Since there are moving parts in the drive station during operation and cleaning can also lead to the undesired contamination of the product, in conventional systems, the drive must be stopped, and the deleterious product or product deposits or bulk material residues must be removed from the drive station, for example by a vacuum cleaner.

To prevent this, according to the invention, a preferably movable intermediate base is provided in the drive station, which is located under the drive. Entrained product or deposits, also known as deleterious product, falls downward onto the intermediate base in the drive station. The intermediate base also has openings, such that the deleterious product falls into a chamber below the intermediate base. By moving in a horizontal direction, a vertical direction, and/or a direction inclined at an angle to the base plate, even deleterious product remaining on the intermediate base can be conveyed downward. In particular, this can be a shaking movement, oscillating movement or a vibratory movement. The chamber below the intermediate base is accessible from the outside through a flap, for example, and can consequently be vacuumed out or cleaned without stopping the machine. Collecting containers, such as drawers or bags, which can be removed and emptied, may also be provided. Emptying can also be performed automatically. Furthermore, a rigid base can be provided below the movable intermediate base, which has openings corresponding to the movable intermediate base. Thus, by moving the movable intermediate base, the openings can optionally be aligned or offset relative to each other.

FIG. 1 shows an exemplary application of the invention in the drive station 1 of a push conveyor. As mentioned above, the invention is not limited to such a drive station, but can also be used in other drive stations of devices for conveying bulk material. The drive station 1 is defined by a housing, wherein the drive 2 is located in the interior of the housing. The interior of the drive station is visible by omitting one of the side panels. According to FIG. 1, a chain drive is used here as drive 2, which conveys the push elements (not shown). If there are product deposits or residues on the push elements, these fall downwards following the force of gravity. A movable intermediate base 3, which has openings, is provided there. The openings can be elongated, oval, angular, round or another shape. The preferably movable intermediate base 3 can be movable horizontally and/or vertically. For example, the movable intermediate base 3 can also be movable at a certain angle with respect to the horizontal, or at an angle to the base plate. This can be accomplished, for example, by support elements in the interior of the drive station, which limit the downward movement of the movable intermediate base 3. Alternatively, rails or similar guide elements and/or pivot points may be provided. The intermediate base 3 can be moved, for example, by means of a lever 4 which is accessible from outside the drive station. Alternatively or additionally, a drive can be provided to move the intermediate base 3. The motor can be activated, for example, after manual actuation of a switch/button, by remote control via a network, at fixed intervals, or the like. The movable intermediate base can also be designed as a grate.

A chamber 5 is formed in the drive station below the movable intermediate base 3. The deposited product falls into this chamber 5 through the openings of the movable intermediate base 3, in particular when the intermediate base 3 is moved, e.g. shaken. The chamber 5 can be accessible from the outside through an opening. The opening can be closed and opened by a flap or cover. At least one drawer can also be provided in the chamber 5, in which the deleterious product collects. In the case of a plurality of drawers, guides corresponding to the number of drawers can also be provided, as shown in FIG. 1. Thus, the deleterious product can be removed from chamber 5 without interfering with production, i.e., while the system continues to run.

In addition, a stationary intermediate base can be provided below the movable intermediate base 3. This stationary intermediate base can have openings corresponding to those of the movable intermediate base, such that they are optionally aligned or offset relative to each other during movement.

FIG. 2 shows a view of a drive station 1 according to the present invention. FIG. 2 corresponds essentially to the structure shown in FIG. 1 and shows the drive station in a sectional view, wherein a view of the interior of the drive station is also shown in perspective by omitting a side wall.

FIG. 3 is an exterior view of a drive station 1 according to the present invention. In this case as well, a drive station 1 of a screw conveyor is shown, but this is not to be understood as limiting. In particular, FIG. 3 shows the cover 6 of the chamber 5 or drawer compartment along with the opening for the conveying means 7.

The present invention also comprises a method for removing bulk material from a drive station, preferably as described above, wherein the method comprising moving a movable intermediate base provided with openings in the drive station. When the intermediate base is moved, residues of bulk material conveyed by a conveying device driven by the drive station, which have accumulated inside the drive station, can be transferred to a chamber or collecting container located under the intermediate base. Furthermore, by cleaning the chamber or pulling out and emptying the collecting container, the bulk material residues can be removed from the drive station even during its operation and thus during the operation of the conveyor driven thereby.

In accordance with the present invention, product deposits or deleterious product deposited in the drive station can be removed during operation via the cover or the removal of drawers from a chamber below the drive. A preferably movable intermediate base with openings is provided which allows product residues to fall through, but separates the chamber from the drive itself. Furthermore, by moving the intermediate base, residues remaining between the openings can be conveyed to the chamber below the drive. Thus, there is no danger for the operating personnel, and the cleaning can be carried out without a safety risk, even by unskilled personnel.

Although the invention is illustrated and described in detail by means of figures and the associated description, this illustration and this detailed description are to be understood as illustrative and exemplary, and not as limiting the invention. It is understood that those skilled in the art may make changes and modifications without departing from the scope of the following claims. In particular, the invention also comprises embodiments having any combination of features that are mentioned or shown above with respect to various aspects and/or embodiments.

The invention also includes individual features in figures, even if they are shown there in connection with other features and/or are not mentioned above.

Furthermore, the term “comprise” and derivatives thereof do not exclude other elements or steps. Likewise, the indefinite article “a” or “an” and derivatives thereof do not exclude a plurality. The functions of a plurality of features listed in the claims may be fulfilled by one unit. The terms “substantially,” “around,” “approximately,” and the like in conjunction with a property or a value also define in particular precisely the property or precisely the value. None of the reference signs in the claims are to be understood as limiting the scope of the claims.

### List of Reference Signs

1 Drive station
2 Drive
3 Movable intermediate base
31 Openings of the intermediate base
4 Lever/handle
5 Chamber/chamber for collecting containers
51 Collecting container
6 Cover/flap
7 Opening for conveying means
8 Stationary intermediate base

1. A drive station for a device for conveying bulk material, wherein the drive station comprises:
a housing having a base plate and side walls, wherein at least one side wall has at least one opening for the passage of a conveying means for conveying the bulk material along a passage path,
a drive for moving the conveying means, wherein the drive is arranged in the housing, and
an intermediate base which is arranged in the vertical direction below the passage path and above the base plate, wherein the intermediate base has openings.

2. The drive station according to claim 1, wherein the intermediate base has a grate.

3. The drive station according to claim 1, wherein the intermediate base is movable.

4. The drive station according to claim 3, further with a stationary intermediate base mounted below the movable intermediate base, wherein the stationary intermediate base has openings,
wherein the movement of the movable intermediate base causes the openings of the bases to be optionally aligned or offset relative each other.

5. The drive station according to claim 3,wherein the movable intermediate base is moved by means of a drive.

6. The drive station according to claim 3, wherein the movable intermediate base is displaced by means of a lever or handle attached to the outside of the housing.

7. The drive station according to claim 1, wherein a chamber is formed below the intermediate base, wherein at least one collecting container, in particular a drawer, is preferably arranged in the chamber.

8. The drive station according to claim 6, wherein the collecting container preferably can be displaced along guides and removed from the housing.

9. The drive station according to claim 1, wherein the openings of the intermediate base and/or the stationary intermediate base are round, oval, elongated or angular.

10. The drive station according to claim 1, wherein the drive is a chain drive, a roller drive, a worm drive, a belt drive, or any other form of drive.

11. The drive station according to claim 7, wherein the chamber is closed by means of a removable cover or flap.

12. A method for removing bulk material from a drive station, preferably according to claim 1, wherein the method comprises moving a movable intermediate base provided with openings in the drive station.

13. The method according to claim 12, wherein when the intermediate base is moved, residues of bulk material conveyed by a conveying device driven by the drive station, which have accumulated within the drive station, are transferred to a chamber or collecting container arranged below the intermediate base.

14. The method according to claim 13, wherein the bulk material residues are removed from the drive station by cleaning the chamber or pulling out and emptying the collecting container.

15. The method according to claim 12, wherein the method is performed during the operation of the drive station.
